(19) United States
(12) Patent Application Publication
(10) Pub. No.: US 2015/0129727 A1
(43) Pub. Date: May 14, 2015

(54) AUTOMATIC TRANSMISSION FILTER RETAINING BRACKET

(71) Applicants: John Marsar, Lake Ronkonkoma, NY (US); Vincent Soviero, Holbrook, NY (US)

(72) Inventors: John Marsar, Lake Ronkonkoma, NY (US); Vincent Soviero, Holbrook, NY (US)

(73) Assignee: PRECISION INTERNATIONAL, Yaphank, NY (US)

(21) Appl. No.: 14/075,540

(22) Filed: Nov. 8, 2013

(51) Int. Cl. B01D 35/30

(52) U.S. Cl. CPC B01D 35/30
USPC 248/94

(57) ABSTRACT

An automatic transmission oil filter retainer includes a base portion; a riser portion extending from a side of the base portion; and a retainer portion extending from a side of the riser opposite the base portion and at right angle to the riser portion, the retainer portion extending parallel to and overlaying the base portion. The base portion is dimensioned with a first short side measuring about 0.56 inches, a second short side measuring about 0.5 inches, and a first long side measuring about 1.39 inches. The through-hole has a diameter of about 0.25 inches. The riser portion is inset along a second long side by about 0.06 inches and extends at 90° from the second short side and the second long side by about 0.59 inches. The retainer portion extends at 90° from the riser portion in a direction towards the first long side by about 0.0305 inches.

### I. FIELD OF THE INVENTION

The present invention relates generally to automotive parts, and more specifically to a retaining bracket for holding an automatic transmission filter in place on the Chrysler® RFE series of automatic transmissions, including the 45RFE transmission, 5-45RFE transmission and 68RFE transmission.

### II. BACKGROUND OF THE DISCLOSURE

The RFE series automatic transmission has an oil filter 116 fixed by a bolt 118 at single point, as shown in FIG. 7. The oil filter outlet 120, shown in FIG. 8, is inserted into a transmission oil pump intake (not shown) with a seal formed therebetween by way of a gasket encircling the oil filter outlet 120. However, by securing the oil filter 116 to the transmission body using only one bolt 118 located at an end of the oil filter 116, located at an opposite end of the oil filter outlet 120, it is possible that the junction between the oil pump intake and the oil filter 116 does not maintain a proper seal. Thus, oil drawn into the oil pump may not be properly filtered. Moreover, the oil pump may not be able to adequately draw in oil since the oil level may not be high enough to submerge the intake of the oil pump.

### III. SUMMARY OF THE DISCLOSURE

An embodiment of the present invention is directed to an oil filter retaining bracket structured with a base portion having a through-hole bored thereon; a riser portion extending from a side of the base portion and at right angle to the base portion; and a retainer portion extending from a side of the riser opposite the base portion and at right angle to the riser portion. The retainer portion extends parallel to and overlays the base portion.

The base portion is dimensioned as a substantially rectangular shape having a first short side measuring about 0.56 inches and a second short side parallel to the first short side measuring about 0.5 inches, and a first long side measuring about 1.39 inches. The through-hole has a diameter of about 0.25 inches, the through-hole being centered at a position about 0.295 inches inset from the first short side, and about 0.279 inches inset from the first long side. The riser portion is inset along a second long side by about 0.06 inches, and extends at 90° from the second short side and the second long side by about 0.59 inches, the second long side being parallel to the first long side. Additionally, the riser portion measures about 0.755 inches along the second long side.

The retainer portion extends at 90° from the riser portion in a direction towards the first long side by about 0.0305 inches. The retainer portion is formed by bending a free end of the riser portion to form a 90° angle therebetween.

### IV. BRIEF DESCRIPTION OF THE DRAWINGS

These and other features, aspects, and advantages of the present invention will become better understood with regard to the following description, appended claims, and accompanying drawings wherein:

FIG. 1 illustrates an isometric projection of an embodiment of the present invention;

FIG. 2 illustrates a first side view of the embodiment of the present invention shown in

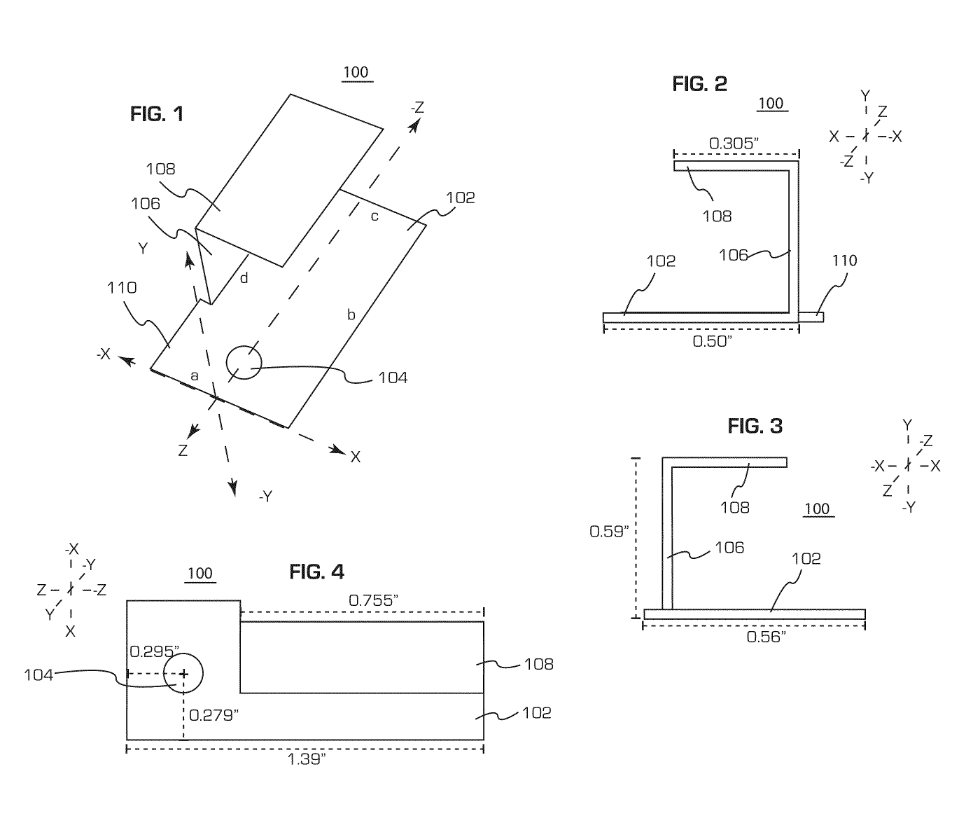

FIG. 1 from the perspective along the −Z to Z direction;

FIG. 3 illustrates a second side view of the embodiment of the present invention shown in FIG. 1 from the perspective along the Z to −Z direction;

FIG. 4 illustrates a plan view of the embodiment of the present invention shown in FIG. 1 from the perspective along the Y to −Y direction;

FIG. 5 illustrates an automatic transmission showing placement of an embodiment of the present invention;

FIG. 6 illustrates an embodiment of the present invention in use holding an oil filter;

FIG. 7 illustrates an RFE series transmission with an oil filter conventionally mounted; and

FIG. 8 illustrates an oil filter for an RFE series transmission.

### V. DETAILED DESCRIPTION OF DISCLOSURE

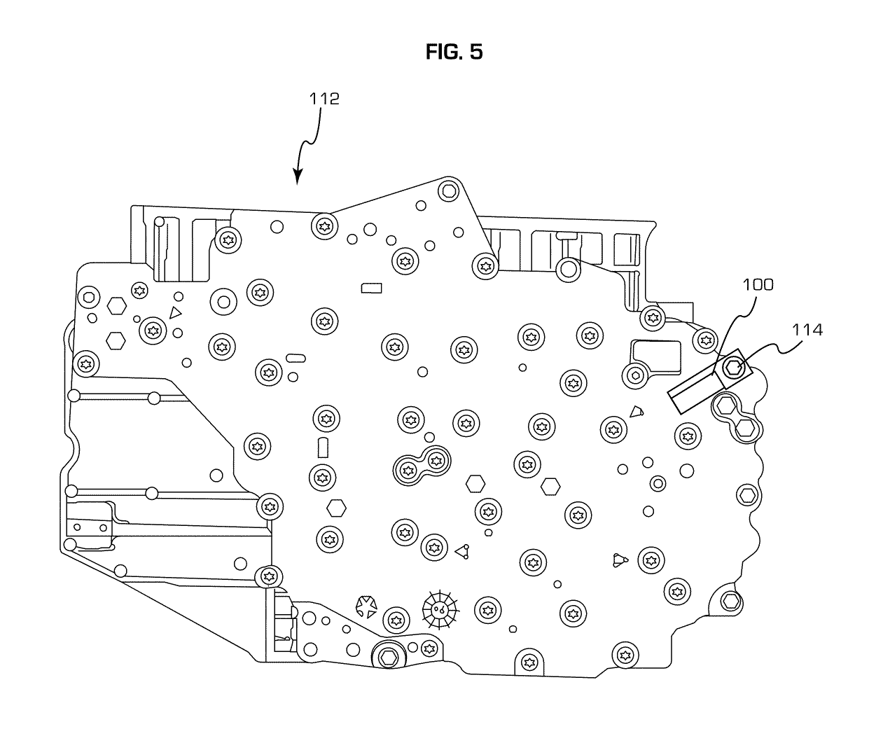

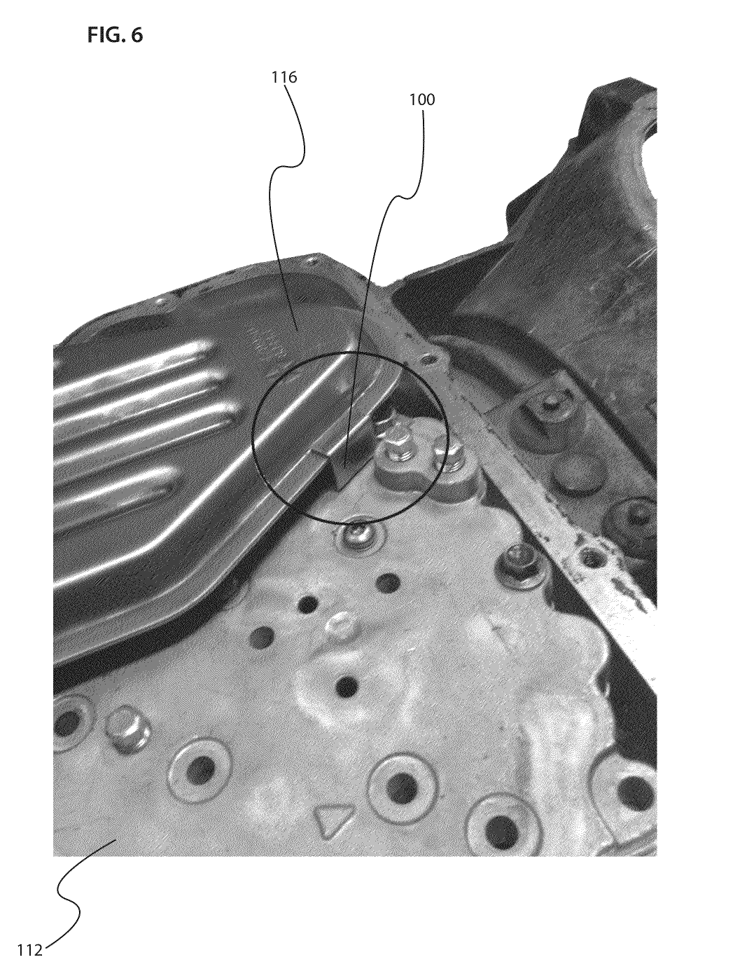

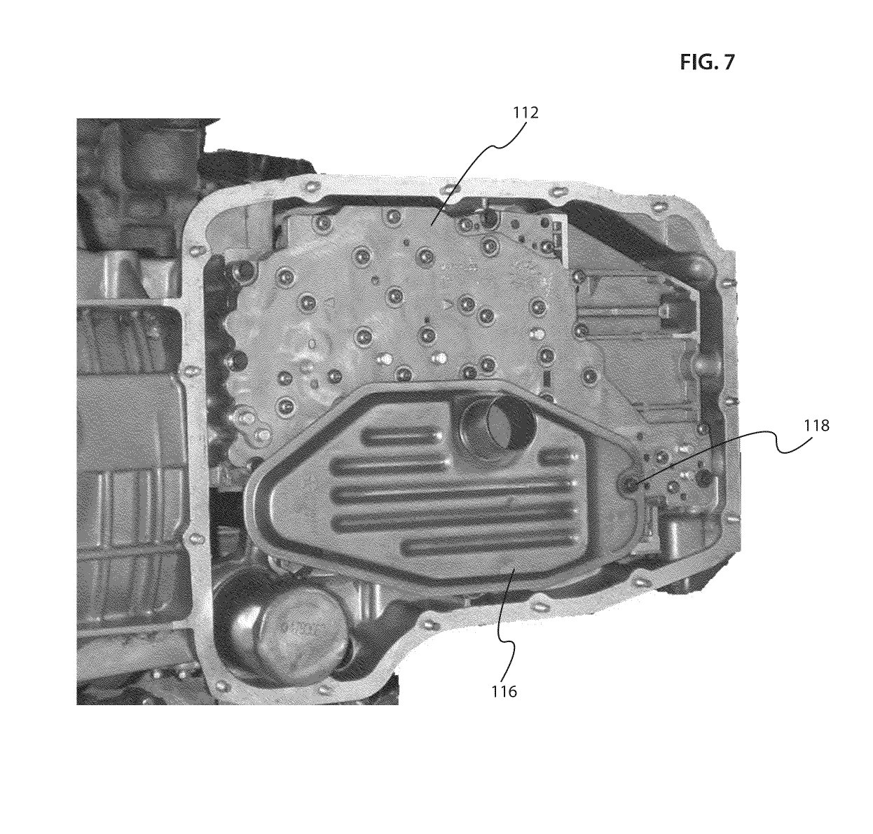

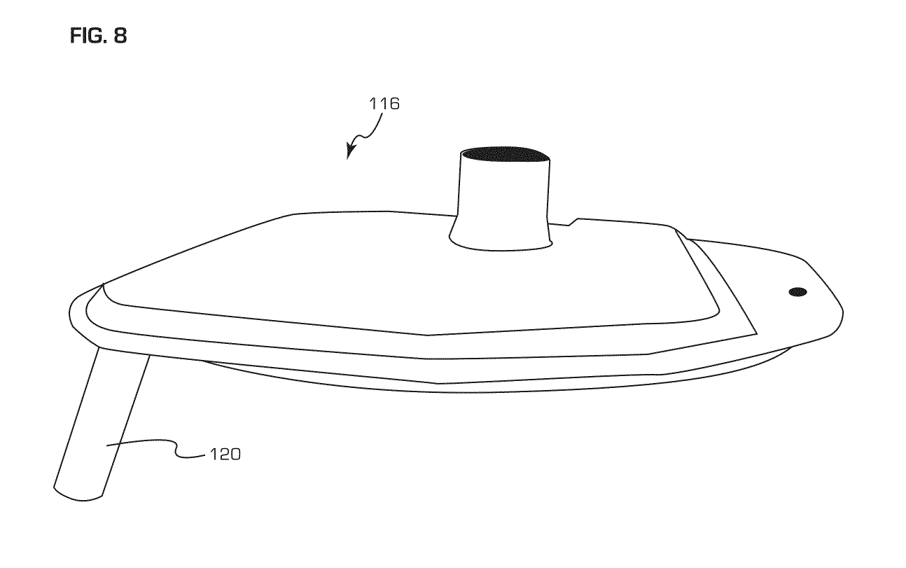

Referring to FIG. 1 through FIG. 4, an embodiment of the present invention is shown in an isometric perspective view. The retaining bracket 100 of the present embodiment is constructed of a single piece of steel, such as SAE 1010 steel or other appropriate alloy having similar mechanical properties. A portion of the single piece of steel forms a base member 102 measuring about 1.39 inches along the Z-axis and about 0.56 inches along the X-axis. A through hole 104, having a diameter of about 0.25 inches, is centered at a position about 0.295 inches inset from a first short side (a) of the base member 102 parallel to the X-axis, and about 0.279 inches inset from a first long side (b) of the base member 102 parallel to the Z-axis.

A riser 106 is bent from the single piece of steel to form a plane parallel with the Y-axis and the Z-axis. The lower portion of the riser 106 is joined to the base member 102 and configured to form a substantially 90° angle therebetween. The riser 106 extends from a second short side (c) of the base member 102 opposite to the first short side (a) to a point about 0.755 inches along the Z-axis. Additionally, the riser 106 is inset from the second long side (d) of the base member 102 opposite the first long side (b) by about 0.06 inches along the X-axis. The riser 106 extends about 0.59 inches along the Y-axis from the bottom surface of the base member 102. A tab 110 is defined on the base member 102 by the inset of the riser 106. The tab 110 is an extension of the base member 102 and provides additional surface area for the bolt 114. However, in an alternative embodiment of the present invention, the tab 110 is omitted.

A top portion of the riser 106 is bent to form a retainer 108. The retainer 108 and riser 106 form a substantially 90° angle therebetween. The retainer 108 extends about 0.0305 inches along the X-axis towards the first long side (b) of the base member 102.

Turning to FIG. 5, an automatic transmission 112 is shown with the filter bracket 100 of the present invention installed. When properly installed, the filter bracket 100 is positioned as shown. The bolt 114 used to fasten the filter bracket 100 in place is the same bolt supplied with the automatic transmission 112. Alternatively, the bolt 114 has a longer shank than the shank of the bolt originally supplied with the automatic transmission 112 that is dimensioned to accommodate the added thickness of the base member 102 of the filter bracket 100. For example, the thickness of the material used to form the filter bracket 100 may be 0.044 inches, thus the bolt 114 would have a shank 0.044 inches longer than the shank of the originally supplied bolt.

As shown in FIG. 6, when properly installed the retainer bracket 100 provides a retaining force on the oil filter 116 at a point near the oil filter outlet 120. Thus, the oil filter is prevented from shifting vertically such that the oil filter outlet 120 separates from the oil pump intake, or otherwise compromises the seal therebetween. It is noted that the specific dimensions shown in FIG. 1-4 are particularly selected in order to provide adequate contact between the filter retaining bracket 100 and the oil filter 116, while allowing the filter retaining bracket 100 to be mounted at a position corresponding to a factory-drilled bolt hole, thus avoiding the need to alter the transmission valve body cover or provide an aftermarket replacement valve body cover.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. An automatic transmission oil filter retaining bracket comprising:
a base portion having a through-hole bored thereon;
a riser portion extending from a side of the base portion, and at right angle to the base portion; and
a retainer portion extending from a side of the riser opposite the base portion, and at right angle to the riser portion, the retainer portion extending parallel to and overlaying the base portion.

2. The automatic transmission oil filter retaining bracket as in claim 1, wherein the base portion is dimensioned as a substantially rectangular shape having a first short side measuring about 0.56 inches and a second short side parallel to the first short side measuring about 0.5 inches, and a first long side measuring about 1.39 inches.

3. The automatic transmission oil filter retaining bracket as in claim 2, wherein the through-hole has a diameter of about 0.25 inches, the through-hole being centered at a position about 0.295 inches inset from the first short side, and about 0.279 inches inset from the first long side.

4. The automatic transmission oil filter retaining bracket as in claim 2, wherein the riser portion is inset along a second long side by about 0.06 inches, and extends at 90° from the second short side and the second long side by about 0.59 inches, the second long side being parallel to the first long side.

5. The automatic transmission oil filter retaining bracket as in claim 4, wherein the riser portion measures about 0.755 inches along the second long side.

6. The automatic transmission oil filter retaining bracket as in claim 2, wherein the retainer portion extends at 90° from the riser portion in a direction towards the first long side by about 0.0305 inches.

7. The automatic transmission oil filter retaining bracket as in claim 6, wherein the retainer portion is formed by bending a free end of the riser portion to form a 90° angle therebetween.

8. The automatic transmission oil filter retaining bracket as in claim 1, wherein the automatic transmission oil filter retaining bracket is configured to provide a retaining force on an oil filter for maintaining contact between the oil filter and an oil pump of an automatic transmission, the retaining force being applied at a point near an outlet of the oil filter connected to the oil pump.

9. The automatic transmission oil filter retaining bracket as in claim 1, wherein the automatic transmission oil filter retaining bracket is configured to be mounted to an automatic transmission at a position corresponding to a preexisting bolt hole in the automatic transmission.

10. An automatic transmission for a vehicle, the automatic transmission comprising:
an oil filter retaining bracket disposed on a surface of a valve body cover of the automatic transmission, the oil filter retaining bracket comprising:
a base portion having a through-hole bored thereon;
a riser portion extending from a side of the base portion, and at right angle to the base portion; and
a retainer portion extending from a side of the riser opposite the base portion, and at right angle to the riser portion, the retainer portion extending parallel to and overlaying the base portion.

11. The automatic transmission as in claim 10, wherein the base portion is dimensioned as a substantially rectangular shape having a first short side measuring about 0.56 inches and a second short side parallel to the first short side measuring about 0.5 inches, and a first long side measuring about 1.39 inches.

12. The automatic transmission as in claim 11, wherein the through-hole has a diameter of about 0.25 inches, the through-hole being centered at a position about 0.295 inches inset from the first short side, and about 0.279 inches inset from the first long side.

13. The automatic transmission as in claim 11, wherein the riser portion is inset along a second long side by about 0.06 inches, and extends at 90° from the second short side and the second long side by about 0.59 inches, the second long side being parallel to the first long side.

14. The automatic transmission as in claim 13, wherein the riser portion measures about 0.755 inches along the second long side.

15. The automatic transmission as in claim 11, wherein the retainer portion extends at 90° from the riser portion in a direction towards the first long side by about 0.0305 inches.

16. The automatic transmission as in claim 15, wherein the retainer portion is formed by bending a free end of the riser portion to form a 90° angle therebetween.

17. The automatic transmission as in claim 10, wherein the retainer is configured to contact and hold an oil filter installed on the automatic transmission.

18. The automatic transmission as in claim 10, wherein the automatic transmission is a Chrysler® RFE series transmission.

19. The automatic transmission as in claim 10, wherein the oil filter retaining bracket is configured to provide a retaining force on an oil filter for maintaining contact between the oil filter and an oil pump of the automatic transmission, the retaining force being applied at a point near an outlet of the oil filter connected to the oil pump.

20. The automatic transmission oil filter retaining bracket as in claim 10, wherein the oil filter retaining bracket is configured to be mounted to the automatic transmission at a position corresponding to a preexisting bolt hole in the automatic transmission.
